(19) United States
(12) Patent Application Publication
(10) Pub. No.: US 2017/0024799 A1
(43) Pub. Date: Jan. 26, 2017

(54) METHODS AND APPARATUS FOR RECOMMENDING TRAVEL OPTIONS

(71) Applicant: MasterCard International Incorporated, Purchase, NY (US)

(72) Inventors: Suneel Bhatt, Delhi (IN); Vipul Mehrotra, Delhi (IN); Sharan Bakshiram, Gurgaon (IN)

(21) Appl. No.: 15/215,134

(22) Filed: Jul. 20, 2016

(30) Foreign Application Priority Data
Jul. 24, 2015 (SG) 10201505795U

(51) Int. Cl. G06Q 30/06; G06Q 30/02

(52) U.S. Cl. CPC G06Q 30/0631; G06Q 30/0201; G06Q 50/12

(57) ABSTRACT

A computer implemented method is proposed for providing prospective travelers with recommendations for merchants (e.g. hotels) to use at their intended destination. A computer collects traveler information relating to one of more individuals who intend to travel, and input specifying the travel destination. The computer identifies previous travelers to the designation who, according to the traveler information, resemble the individual(s), and forms a recommendation of merchants at the destination using transaction data specifying the payment transactions made to merchants in the destination by the previous travelers.

### CROSS-REFERENCE TO RELATED APPLICATION

This application is a U.S. National Stage filing under 35 U.S.C. §119, based on and claiming benefit of and priority to SG Patent Application No. 10201505795U filed Jul. 24, 2015.

### TECHNICAL FIELD

The present disclosure relates to methods and systems for providing an individual who wants to travel to a particular travel destination with recommendations for merchants offering products at that destination, and in particular merchants offering lodging in the destination.

### BACKGROUND

Many people spend a significant fraction of their annual income on an annual vacation. Planning is critical in order to benefit from this expense. The most critical choice is the destination itself, but even after choosing a destination the person planning the travel has to make a choice of which merchants to use to purchase any goods or services (in this document referred to collectively as “products”) in the destination. For example, it is very important to choose an appropriate hotel to stay in at the destination. The term “hotel” is used in this document to describe any place which offers lodging (in particular, temporary lodging) to visitors on a paid basis, and thus includes not only conventional hotels but also guest houses, serviced apartments, and even rented rooms. The term “destination” is used to mean a geographical region, such as a town, or a county, or a predefined section of a town or county. Typically a destination is large enough to include a plurality of hotels.

Although there is endless information about travel destinations available on internet, much of it is unreliable. For example, the websites of hotels typically provide carefully selected images which are not typical of the experience of a traveler staying in the hotel. Social media websites such as Tripadvisor.com contain reviews written by people who allege that they have stayed at the hotel, but in some cases these reviews are actually written by individuals who are not genuine travelers, such as individuals associated with the hotel (or with the hotel's competitors), and the reviews contain biased information. Even if the reviews are by genuine travelers, those travelers may be untypical (e.g. only those travelers who have had a bad experience, or only travelers from a certain demographic). Furthermore, a small hotel may not be reviewed at all, or very rarely, so any reviews available for it may be old and give out of date information. For these reasons, it is hard to rely on the information available online.

### SUMMARY

In general terms, the present disclosure proposes that a computer system collects traveler information relating to one of more individuals who intend to travel, and input specifying a travel destination (that is, a geographical region, such as a town, in which a plurality of merchants offer products). The computer identifies previous travelers to the destination who, according to the traveler information, resemble the individual(s), and forms a recommendation of one or more merchants at the destination using transaction data specifying the payment transactions made to merchants in the destination by those previous travelers.

The transaction data is data describing real payment transactions, and thus it is harder for a merchant in the destination to tamper with than reviews on social media websites. Even a small hotel will typically have many transactions per day, so a large volume of up-to-date transaction data may be available. Furthermore, since the previous travelers resemble the individuals, the information should be relevant to the demographics of the individuals.

The merchants may be hotels at the destination. However, the invention is not limited in this respect, and the merchants may for example be restaurants at the destination, and/or tourist attractions or tourist guides at the destination. In some cases the merchant to which a payment transaction has been made may be part of a merchant company operating at a plurality of destinations (e.g. a hotel chain which operates hotels in many cities), and in this case the transaction data used is data relating to just to one of the destinations. Indeed, a single merchant company may operate at several locations within a single destination (e.g. several hotel chains operate multiple hotels in New York), and in this case the transaction data is broken down as between these locations, so as to provide a recommendation of a single one of the locations. Thus, the term “merchant” refers to a single location (e.g. a single hotel of a hotel chain).

Typically, the computer which performs the method may be a server, which the person planning the travel (here referred to as the “user”; note that in some cases there may be a plurality of individuals who cooperate together to plan the travel (e.g. a married couple), and the term “user” is used here to include these multiple individuals) is able to access using a communication device which connects to the server over a communication network, e.g. over the internet. For example, the server may provide a website interface. Alternatively, the computer which performs the method may be the communication device itself, such as a communication device having an installed application which performs the method, including accessing transaction data from a server over a communication network. The transaction data received by the communication device may be summarized and anonymized. The term “communication device” refers a piece of equipment or hardware which is capable of transmitting and receiving data electronically. It may be a computer device such as a mobile phone (e.g. smartphones or conventional/feature phones), a tablet, a desktop computer, a laptop computer or a smart watch etc.

Typically, a user registers to use the method. If the computer is a user's communication device, the registration process may include downloading an app into the communication device.

The registration process typically includes supplying information specifying a payment account associated with a payment card. As used in this document, the term “payment card” refers to any suitable cashless payment device, such as a credit card, a debit card, a prepaid card, a charge card, a membership card, a promotional card, a frequent flyer card, an identification card, a prepaid card, a gift card. The payment account information supplied may for example comprise a Primary Account Number (PAN) of a payment card. In one possibility the user may input the payment account information manually into the communication device. Alternatively, the communication device itself may already contain payment account information (e.g. stored as part of a digital wallet), and in this case the payment account information may be supplied as an input to the present method without the user entering it again.

The computer may obtain some or all of the traveler information automatically using the payment account information. For example, the computer may use the payment account information to access the user's transaction data, to get information about the user's prior transactions and/or geo-information about the user (such as a base location). Alternatively or additionally, the user may input some or more the traveler information into the communication device using a data input device such as a keyboard or touch-sensitive screen.

The user may choose a base location to be the start of his or her journey. This may be the current location of the communication device (e.g. obtained automatically, such as by GPS), or a location associated with the payment account, or another selected location.

The previous travelers are individuals who hold a payment card associated with a payment account (“payment account holders”). Payments using the payment card are administrated using a payment network such as the one operated by MasterCard International Inc. The process of identifying previous travelers who resemble the user uses descriptor data about the previous travelers, and one or more similarity criteria. The similarity criteria may take account any one or more of:
Whether the previous travelers are associated with transaction behavior which is similar to the transactional behavior of the user;
Whether the previous travelers are from same geographical region as (e.g. within a predetermined distance from) the user. For example, the previous travelers may be ones for which a location associated with their respective payment accounts is within a predetermined distance of a location associated with a location associated with the user. The selection of previous travelers may comprise identifying the previous travelers by comparing their zip locations with the user, or whether they are in the same city as the user.

As noted above, the previous travelers are ones who have traveled to the destination to which the user wishes to travel. Additionally, the previous travelers may be required to have travelled to the destination within one or more time windows. For example, they may be ones who have travelled to the destination no more than a certain time in the past. Furthermore, they may be selected as ones who travelled to the destination during one or more ranges of dates selected based on the desired travel dates, e.g. in the same month as the desired travel dates, or the same season of the year as the desired travel dates. The desired travel dates may be ones entered by the user, or may by default be taken as dates following the date on which the method is carried out.

Furthermore, the previous travelers may be ones who resemble the user according to one or more other characteristics, such as any demographic information about the user and previous travelers which may be available. For example, the traveler information about the user may comprise any one or more of: his or her age; his or her gender; whether he or she will be travelling with other individuals (e.g. a spouse and/or children). In this embodiment, the previous travelers will be selected to be ones who resemble the user in such demographic characteristics.

The process of generating the recommendation(s) of merchants may be based on generating score data for each of the merchants, indicating a respective score (numerical rating) for each of the merchants, and recommending the merchants with the highest scores (e.g. in the order of the scores).

The score may depend on the number of the previous customers which have made transactions to the merchant (or equivalently the number of payment cards which have been used for payment transactions to the merchant; these numbers are equal if each of the previous customers has only one respective payment card associated with the payment network). This provides more reliable information than the total money spent or the total number of transactions, either of which may reflect transactions by a very small number of previous travelers, who may be unrepresentative. By contrast, recommendations based on the number of payments cards used provides information about the number of previous travelers similar to the user using the merchant.

Additionally or alternatively, a number of other pieces of data derived from the transaction data of the previous customers may be used to form the recommendation, such as:
Duration of Stay: This can be inferred from the transaction data by identifying all the transactions (i.e. not just with the same merchant) which a given previous traveler makes in the destination. For example, even if a given previous traveler only makes one payment at a hotel, he may make payments to restaurants and/or tourist organizations each day of his stay in the destination.
Repeat Customers: It can be determined from the transaction data whether the previous travelers repeatedly use the same merchant. For example, if in a given destination it is determined that previous travelers have tended to use the same hotel repeatedly, this is an indication that they liked the hotel. Conversely, if previous travelers who have used a given first hotel on a first visit to the destination tend on future visits to use a different hotel, this may be an indication that they did not like the hotel.
Share of Wallet/Customer Loyalty: This means how much previous travelers have spent with a particular merchant as compared to other merchants within the same industry. For example, if travelers to a certain destination tend to spend most of their money at a certain restaurant, rather than other restaurants, this is an indication that the restaurant is good.
Trend Analysis: The transaction data may be analyzed to extract trends in the data, and this can be used in forming a recommendation also. For example, if it can be shown that a particular merchant, or a particular destination, is continuously showing growth, that merchant, or merchants in that destination can be recommended more highly.

### BRIEF DESCRIPTION OF THE DRAWINGS

Embodiments of the invention will now be described as of non-limiting examples only, with reference to the following drawings in which:

FIG. 1 illustrates schematically the performance of the invention using a server which is a first embodiment of the invention;

FIG. 2 is a block diagram illustrating a technical architecture of the server of FIG. 1;

FIG. 3 is a flow diagram illustrating process steps which are performed by the server of FIG. 1; and

FIG. 4 is a block diagram illustrating a technical architecture of a communications device which is a second embodiment of the invention.

### DETAILED DESCRIPTION

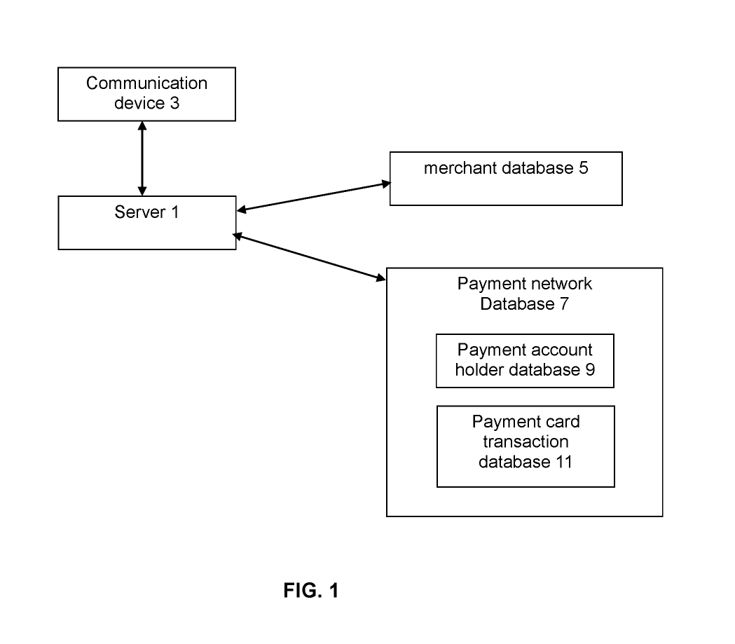

FIG. 1 illustrates a server 1 for providing recommendations to a user who operates a communication device 3. The communication device 3 is in communication with the server 1, for example over a wide area network such as the internet. The server 1 is also in communication with a merchant database 5 which for each of a plurality of destinations stores information about one or more merchants offering products at that destination. The information is broken down by product category, and this breakdown may be hierarchical according to a hierarchy of increasingly specific product categories. Thus, the database 5 may store information about all hotels in each destination, and this may be further broken down in to (i) high-end hotels and low-end hotels; (ii) hotels at particular types of locations, such as sea-front hotels, etc.

The server 1 is also in communication with a database 7 storing data generated by a payment network, which may for example be the payment network of Mastercard International Inc. The database 7 has a first portion 9 storing descriptor data describing a plurality of payment account holders, including respective demographic information. The database 7 has a second portion 11 which for each of the payment account holders stores transaction data of the associated payment cards.

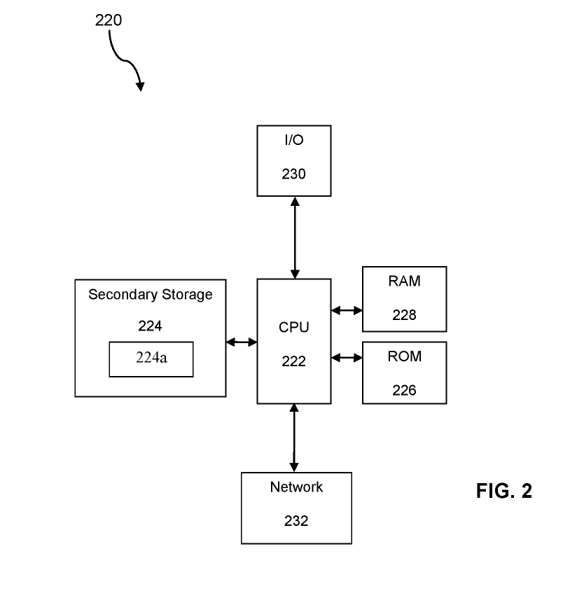

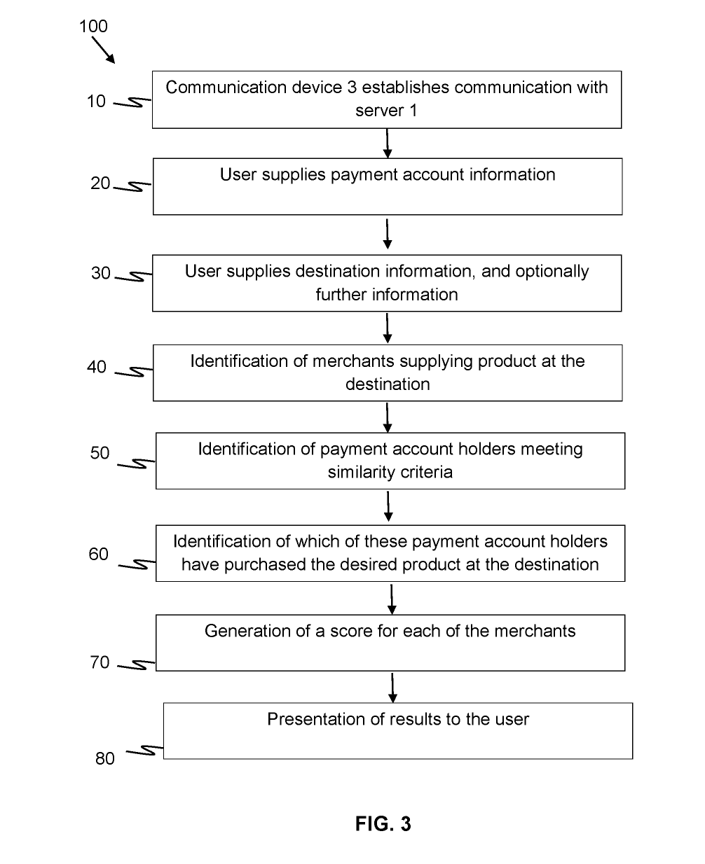

FIG. 2 is a block diagram showing a technical architecture of the server 1 for performing an exemplary method 100 which is described below with reference to FIG. 3. Typically, the method 100 is implemented by a computer having a data-processing unit. The block diagram as shown FIG. 2 illustrates a technical architecture 220 of a computer which is suitable for implementing one or more embodiments herein.

The technical architecture 220 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 220 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 220, at least one of the CPU 222, the RAM 228, and the ROM 226 are changed, transforming the technical architecture 220 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

FIG. 3 shows the steps of a method 100 according to an embodiment of the invention. In a first step 10 the user uses the communication device 3 to establish communication with the server 1, for example to enter data into a graphical user interface (GUI) defined by the server 1. In step 20, the user registers with the server 1 and enters payment account information indicating a payment account associated with a payment card. Note that if the user has used the service provided by the server 1 on a previous occasion, then step 20 may be replaced by a log-in service in which the server 1 accesses payment account information from the previous occasion.

In step 30 the user enters further information about the holiday he wishes to take, including the destination and optionally the dates of travel, and at least one category of product about which the user would like information. This may be done by specifying one (or more) of the product categories for which the database 5 stores corresponding merchants. The user may choose at least one wide product category (e.g. “hotel”) or at least one more specific product category (e.g. “five star hotels” or “sea-front hotels”). Optionally the user may enter information (“traveler information”) about himself or herself, such as his or her age or a base location (e.g. where he or she lives).

In step 40, the server 1 accesses the database 5 to find one or more merchants of the type specified by the user and providing products at the destination. In step 50, the server 1 accesses the database portion 9 to obtain any further information which may be available about the user to supplement the traveler information. For example, if the user has not entered a base location at step 30, the server 1 may be able to obtain this information from the database portion 9 as a location associated with the user's payment account.

In step 50 the server uses the database portion 9 to identify a plurality of other payment account holders whose descriptor data observes one or more similarity criteria to the traveler information. This can include one or more of (i) a base location for the payment holder which is similar to that of the user (e.g. same town, or within a predetermined distance), (ii) ages differing by less than a threshold, (iii) same gender, etc.

In step 60, the server 1 accesses the database portion 11 and identifies all these payment holders who have made payment transactions at the destination during at least one time window (e.g. selected based on the user's dates of travel) to a merchant of the type specified by the user. Thus, these payment holders both (i) obey the similarity criteria to the user, and (ii) are previous travelers to the destination who have made a payment at a merchant of the specified type during the time window(s). It is to be appreciated that steps 50 and 60 may be performed in the opposite order (i.e. identifying firstly those payment account holders in the database portion 11 who have made a payment at the destination, and then which of those payment account holders obey the similarity criteria to the user).

In step 70, the server accesses all the data in the database portion 11 relating to these previous travelers, and uses it to generate respective score data indicating a respective score (numerical rating) for each of the identified merchants.

In step 80 the server 1 generates and transmits to the communication device 3 information sufficient for the communication device 3 to provide recommendations concerning the merchants identified in step 40. For example, the server 1 may generate HTML or XML code which a browser of the communication device 3 can use to generate a window presenting the recommendations on a screen of the communication device 3.

A simple way to do this is to present the identified merchants to the user on the screen of the communication device 3, in an order according to the score obtained by the server 1 for each merchant.

The score may for example be the number of the previous travelers who have made payment transactions to the merchant. Alternatively the identified merchants may be listed in another order, but with the corresponding score displayed.

Various refinements of this system are possible. For example, the score may be based on multiple factors, and the identified merchants (or at least, a sub-set of them with the highest scores) may be presented to the user on a screen of the communication device 1, in an order according to the score. The factors may include any one or more of:
the number of payment account holders identified in step 60 who have made payment transactions to the merchant within the time window(s). An initial value of the score (which is subsequently modified using one or more of factors b-e below) may be a function of this number of payment account holders. Optionally, the initial score may be normalised, to compensate for the fact that merchants are of different sizes (e.g. hotels are of different sizes). For example, by generating the initial score as the number of payment account holders (i.e. the ones identified in step 60 as obeying the similarity criteria) who have used a certain merchant, divided by the total number of payment accounts which have made a payment at the merchant during the time window(s), the initial score would give a strong indication of the preferences of previous travelers resembling the user.
In the case of a merchant which is a hotel, the average duration of the stay the payment account holders identified in step 60 made at the hotel. This can be inferred from the transaction data by identifying all the transactions which those payment account holders made in the destination (i.e. not just at the hotel), and finding the time range which these transactions span. In the case that the payment account holders stayed at the hotel for a longer time, the initial score may be increased.
Whether any of the payment account holders identified in step 60 have chosen to use the merchant more than once. For example, if in a given destination it is determined that those payment account holders have tended to use the same hotel repeatedly, this is an indication that they liked the hotel, and a certain value may be added to the score. Conversely, if those payment account holders who have used a given first hotel on a first visit to the destination tend on future visits to use a different hotel, this is a strong indication that they did not like the hotel, and a value may be subtracted from the initial score.
Share of Wallet/Customer Loyalty: This means how much payment account holders identified in step 60 have spent with the particular merchant as compared to other merchants within the same industry. For example, if those payment account holders tended to spend most of their money at a certain restaurant, rather than other restaurants, this is an indication that the restaurant is good, and a certain value may be added to the initial score.
Trend Analysis. For example the server may determine that there is a rising trend in the number of previous payment account holders identified in step 60 who have used a given merchant. If so, a value may be added to the initial score of the merchant, e.g. one which is a function of the amplitude of the rising trend.

FIGS. 1-3 explain the invention in terms of the method 100 being performed by a server. However, alternatively the method may be performed by the communication device 3, having downloaded appropriate software from the server 1. The communication device 3 may communicate with the server 1 to obtain data which is required, such as from the databases 5 and 7. All the steps of method 100 are then performed by the communication device 3, although if the communication device already stores information identifying a payment account of the user, that information may be accessed in step 20, rather than it being entered again.

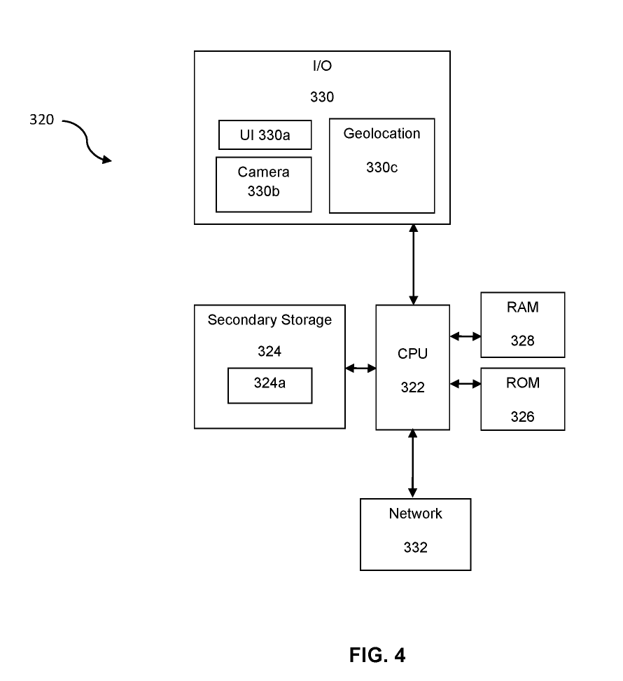

FIG. 4 is a block diagram showing a technical architecture of the consumer device 3. It is envisaged that in embodiments, the communication device will be a smartphone or tablet device. The block diagram as shown FIG. 3 illustrates a technical architecture 320 of a communication device which is suitable for implementing one or more embodiments herein.

The technical architecture 320 includes a processor 322 (which may be referred to as a central processor unit or CPU) that is in communication with memory devices including secondary storage 324 (such as disk drives or memory cards), read only memory (ROM) 326, random access memory (RAM) 328. The processor 322 may be implemented as one or more CPU chips. The technical architecture 320 further comprises input/output (I/O) devices 330, and network connectivity devices 332.

The I/O devices comprise a user interface (UI) 330a, a camera 330b and a geolocation module 330c. The UI 330a may comprise a touch screen, keyboard, keypad or other known input device. The camera 330b allows a user to capture images and save the captured images in electronic form. The geolocation module 330c is operable to determine the geolocation of the communication device using signals from, for example global positioning system (GPS) satellites.

The secondary storage 324 is typically comprised of a memory card or other storage device and is used for non-volatile storage of data and as an over-flow data storage device if RAM 328 is not large enough to hold all working data. Secondary storage 324 may be used to store programs which are loaded into RAM 328 when such programs are selected for execution.

In this embodiment, the secondary storage 324 has an order generation component 324a, comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present invention.

1. A computer-implemented method for presenting merchant recommendations to a user who plans to travel to a destination, the method comprising:
(a) a computer system receiving traveler information describing the user,
(b) the computer system receiving input specifying the destination,
(c) the computer system accessing a merchant database storing data specifying respective locations at which a plurality of merchants offer products, to identify one or more said merchants who offer a product in the specified destination;
(d) the computer system accessing a payment network database storing descriptor data which for each of multiple payment account holders specifies respective information describing the payment account holders, and transaction data describing payment transactions the respective payment account holders have made;
(e) the computer system identifying one or more of the payment account holders for whom:
(i) the corresponding descriptor data and the traveler information meet one or more similarity criteria; and
(ii) the corresponding transaction data indicates the payment holder has made a payment transaction at merchant at the destination;
(f) the computer system generating, from the transaction data for the identified payment account holders, respective score data indicative of respective scores for the identified merchants; and
(g) the computer system generating data to provide a display to the user which indicates one or more of the identified merchants, the display depending on the respective score data of the merchants.

2. A computer-implemented method according to claim 1 further including the computer system, prior to step (c), receiving user input specifying a type of product the user wishes to obtain at the destination,
the computer system in step (c) identifying merchants who offer a product of the specified type at the destination.

3. A computer-implemented method according to claim 1 in which the merchants identified in step (c) are hotels.

4. A computer-implemented method according to claim 1 further including the computer system using payment account information associated with the user, to obtain some or all of the traveler information.

5. A computer-implemented method according to claim 1 including determining a date when the user intends to travel to the destination, generating one or more time windows based on the date, and, in step (e), identifying the one or more payment account holders as payment account holders for whom the corresponding transaction data indicates the payment account holder has made a payment transaction to a merchant at the destination within the one or more time windows.

6. A computer-implemented method according to claim 1 in which the similarity criteria include a similarity criterion comparing a base location associated with the user with a location associated with a said payment account holder.

7. A computer-implemented method according to claim 1 in which the similarity criteria include a similarity criterion comparing transaction behavior of the user with transactional behavior of a said payment account holder.

8. A computer-implemented method according to claim 1 in which the similarity criteria include a similarity criterion comparing demographic characteristics of the user with demographic characteristics of a said payment account holder.

9. A computer-implemented method according to claim 1 in which, for a given identified merchant, the respective score data is generated in dependence on the number of identified payment account holders who have made a payment at the merchant.

10. A computer-implemented method according to claim 9 in which the said number of identified payment account holders who have made a payment at the merchant is normalized by a total number of payment account holders who have made a payment at the merchant.

11. A computer-implemented method according to claim 1 in which, for a given identified merchant, the respective score data is generated in dependence on how many of the identified payment account holders have made repeated payments to the merchant.

12. A computer-implemented method according to claim 1 in which, for a given identified merchant, the respective score data is generated in dependence on how much the identified payment account holders have spent with the merchant as compared to other merchants offering a product of the same type at the destination.

13. A computer-implemented method according to claim 1 in which, for a given identified merchant, the transaction information is analyzed to identify a trend, and the respective score data is generated in dependence on the identified trend.

14. A computer-implemented method according to claim 1 in which the merchants are hotels, and for a given identified hotel, the respective score data is generated in dependence on the duration of stays at the hotel made by the identified payment account holders.

15. A computer system comprising:
a processor arranged to access (i) a merchant database storing data specifying respective locations which a plurality of merchants offer products, and (ii) a payment network database storing descriptor data which for each of multiple payment account holders specifies respective information about the payment account holders, and transaction data describing payment transactions the payment account holders have made; and
a data storage device storing program instructions operative, when implemented by the processor, to cause the processor to perform a method including:
(a) receiving traveler information describing the user,
(b) receiving input specifying the destination,
(c) accessing the merchant database to identify one or more said merchants who offer a product in the specified destination;
(d) accessing the payment network database;
(e) identifying one or more of the payment account holders for whom:
(i) the corresponding descriptor data and the traveler information meet one or more similarity criteria; and
(ii) the corresponding transaction data indicates the payment holder has made a payment transaction at merchant at the destination;
(f) generating, from the transaction data for the identified payment account holders, respective score data indicative of respective scores for the identified merchants; and
(g) generating data to provide a display to the user which indicates one or more of the identified merchants, the display depending on the respective score data of the merchants.

16. A computer program product storing non-transitory computer instructions operative, when implemented by a processor, to cause the processor to perform a method including:
(a) receiving traveler information describing the user,
(b) receiving input specifying the destination,
(c) accessing a merchant database storing data specifying respective locations at which a plurality of merchants offer products, to identify one or more said merchants who offer a product in the specified destination;
(d) accessing a payment network database storing descriptor data which for each of multiple payment account holders specifies respective information describing the payment account holders, and transaction data describing payment transactions the respective payment account holders have made;
(e) identifying one or more of the payment account holders for whom:
(i) the corresponding descriptor data and the traveler information meet one or more similarity criteria; and
(ii) the corresponding transaction data indicates the payment holder has made a payment transaction at merchant at the destination;
(f) generating, from the transaction data for the identified payment account holders, respective score data indicative of respective scores for the identified merchants; and
(g) generating data to provide a display to the user which indicates one or more of the identified merchants, the display depending on the respective score data of the merchants.
